(19) United States
(12) Patent Application Publication
(10) Pub. No.: US 2002/0001377 A1
(43) Pub. Date: Jan. 3, 2002

(54) Method for state signaling for a subscriber connection in a communications network with communications systems

(76) Inventors: Ian Catley, Puchheim (DE); Martin Gartner, Taufkirchen (DE); Hans-Peter Vow Ow, Muenchen (DE); Wolfgang Fraas, Wolfratshausen (DE); Stefan Honold, Muenchen (DE)

Correspondence Address: Bell, Boyd & Lloyd LLC, P.O. Box 1135, Chicago, IL, 60690, US

(21) Appl. No.: 09/825,086

(22) Filed: Apr. 2, 2001

(30) Foreign Application Priority Data
Mar. 31, 2000 (DE) 10016244.4

(51) Int. Cl. H04M 3/42; H04M 7/00

(52) U.S. Cl. 379/207.04; 379/232

(57) ABSTRACT

A method in which at least one memory, which is associated with at least one first subscriber connection, is used to store a cross-reference to a second subscriber connection whose state is signaled at the first subscriber connection. For allocation of the first subscriber connection to a first communications system and allocation of the second subscriber connection to a second communications system, the at least one first subscriber connection is allocated group information, and the group information is stored, for message compression, in a memory which is associated with the second subscriber connection. Furthermore, in the event of a state change of the second subscriber connection, a message relating to the state change is sent with the group information to the first communications system, for transmission of a message with information about the state change to the first subscriber connection.

### BACKGROUND OF THE INVENTION

1. Field of the Invention

The present invention relates to a method for state signaling for a subscriber connection in a communications network with communications systems, wherein a memory which is associated with a first subscriber connection to which a state of a second subscriber connection is to be signaled is used to store a cross-reference to the second subscriber connection, whose state is to be signaled.

2. Description of the Prior Art

Within a communications system, it is possible to signal state information to dialed destinations, which can be dialed via direct call keys on a communications terminal, on visual display devices which are associated with direct call keys on other communications terminals. For example, a rapidly flashing light-emitting diode can be used to signal an incoming call, a slowly flashing light-emitting diode can be used to signal a state of a parked connection, and a switched-off light-emitting diode can be used to signal a free dialed destination (Hicom 300E V2.0, Description of service features, Section 3.16 and Section 5.3.1, Apr. 23, 1999, Siemens Part Number: P31003-G1036-L100-3-18). A functionality such as this has until now been feasible only within a communications system. To provide the functionality, a memory which is associated with a first subscriber connection to which the state of a second subscriber connection is to be signaled is used to store a cross-reference to the second subscriber connection, whose state is to be signaled. In a corresponding manner, a memory which is associated with the second subscriber connection is used to store a reference back to the first subscriber connection.

An object to which the present invention is directed is to specify a method for state signaling between communications systems for a subscriber connection in a communications network having a number of communications systems.

### SUMMARY OF THE INVENTION

According to the present invention, at least one memory which is associated with at least one first subscriber connection is used to store a cross-reference to a second subscriber connection. The state of the second subscriber connection can be signaled at the first subscriber connection. For allocation of the first subscriber connection to a first communications system and allocation of the second subscriber connection to a second communications system the at least one first subscriber connection is allocated group information. This group information is stored in a memory which is associated with the second subscriber connection. In the event of a state change of the second subscriber connection, a message relating to the state change is sent with the group information to the first communications system in order to transmit the message onward from there to the first subscriber connection.

An aspect of the method according to the present invention is that, if there are a large number of first subscriber connections to which the state of a second subscriber connection is to be signaled, only a single group information item need be stored in the memory for the second subscriber connection. Even in the case of state signaling between communications systems, this is a major advantage since only one message relating to a state change need be sent per partner communications system within the communications network. This, in turn, contributes to a reduction in the load on the transmission channels. This is extremely advantageous, particularly when transmitting state change messages via signaling channels.

According to one advantageous embodiment of the present invention, in the situation where the first subscriber connection and the second subscriber connection are allocated to the same communications system, a reference back to the first subscriber connection is stored in a memory which is associated with the second subscriber connection. In the event of a state change of the second subscriber connection, a message relating to the state change is then sent directly to the first subscriber connection.

Additional features and advantages of the present invention are described in, and will be apparent from, the following Detailed Description of the Preferred Embodiments and the Drawings.

### DESCRIPTION OF THE DRAWINGS

FIG. 1 shows a communications network having two communications systems and subscriber connections, whose state is to be signaled on other subscriber connections, or on which the state of other subscriber connections is signaled.

### DETAILED DESCRIPTION OF THE PREFERRED EMBODIMENTS

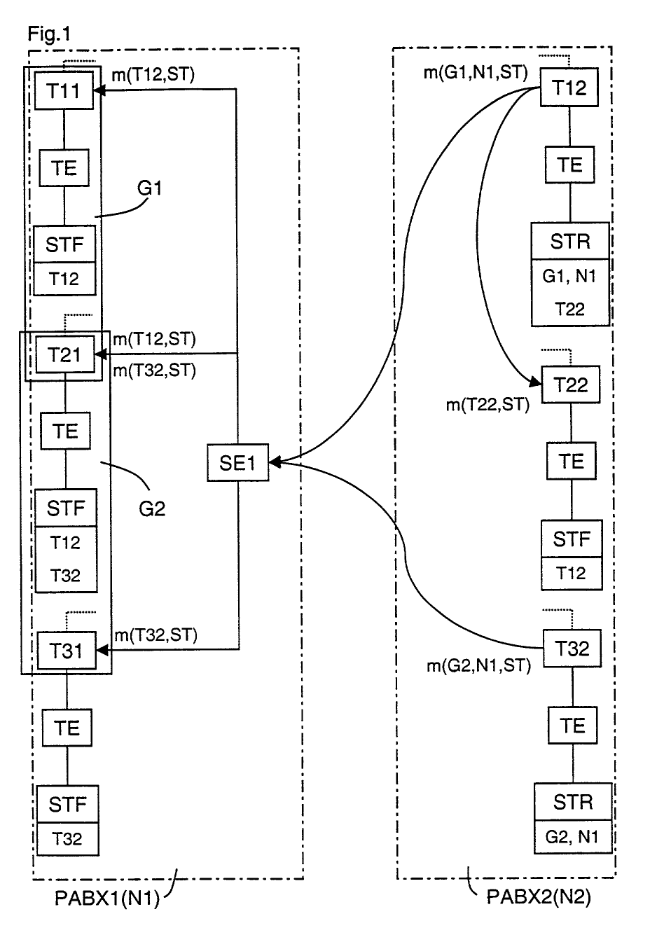

FIG. 1 shows a communications network having two private branch exchange systems PABX1 and PABX2. The private branch exchange system PABX1 is allocated subscriber connections T11, T21 and T31, on each of which the state of at least one other subscriber connection is signaled. The private branch exchange system PABX2 is allocated subscriber connections T12 and T13, whose state is signaled on another subscriber connection, and is allocated a subscriber connection T22, on which the state of another subscriber connection is signaled.

The subscriber connections T11, T21, T31 and T22 are each allocated a subscriber terminal TE having a memory STF in which cross-references are stored to the subscriber connections whose state is to be signaled. In the present case, the memory STF associated with the subscriber connection T11 contains a cross-reference to the subscriber connection T12 of the private branch exchange system PABX2. Furthermore, the state of the subscriber connection T12 is to be signaled on the subscriber connection T21. For this reason, the memory STF associated with the subscriber connection T21 likewise has a cross-reference to the subscriber connection T12. Since the subscriber connections T11 and T21 are allocated to the private branch exchange system PABX1, while the subscriber connection T12 is allocated to the private branch exchange system PABX2, the subscriber connections T11 and T21 are allocated group information G1. This group information GI is also stored in a memory STR associated with the subscriber connection T12. Furthermore, a node number N1 for the private branch exchange system PABX1 is stored there in addition to the group information G1, as a unique identification tag within the communications network. The private branch exchange system PABX2 is allocated the node number N2. Alternatively, it will be possible to use, within the communications system, group information which allows clear conclusions to be drawn relating to the association between those subscriber connections which are provided with corresponding group information and a specific private branch exchange system.

Analogously to the allocation of the group information G1 to the subscriber connections T11 and T21, the subscriber connections T21 and T31 are allocated group information G2, since the state of the subscriber connection T32 associated with the private branch exchange system PABX2 is to be signaled on both subscriber connections. For this reason, the memories STF which are associated with the subscriber connections T21 and T31 via a subscriber terminal TE each contain a cross-reference to the subscriber connection T32. Furthermore, the group information G2, including the node identification number N1 of the first private branch exchange system PABX1, is stored in the memory STR associated with the subscriber connection T32. The association of group information is particularly simple if the subscriber connections to which common group information is allocated are members of a network-wide call transfer group. In this case, this results in additional configuration complexity only for the call transfer group.

Furthermore, the state of the subscriber connection T12 can be signaled on the subscriber connection T22 which is associated with the same private branch exchange system PABX2. The memory STF associated with the subscriber connection T22 thus has a cross-reference to the subscriber connection T12. In contrast to the situations described above, the memory STR associated with the subscriber connection T12 is used to store a direct cross-reference back to the subscriber connection T22 and not to store any group information, since the subscriber connections T12 and T22 are allocated to the same communications system PABX2.

In the event of a state change of the subscriber connection T12, a message m(T22, ST) relating to the state change is sent with information relating to the present state ST to the subscriber connection T22. Furthermore, a message m(G1, NT, ST) indicating the state change ST of the subscriber T12 is sent with the group information G1 and the node number N1 as a sum message to a control unit SE1 for the private branch exchange system PABX1. In this case, the associated message is sent only once for all the group members to the private branch exchange system PABX1. The received message relating to the state change of the subscriber connection T12 is evaluated in the control unit SE1 of the private branch exchange system PABX1, using the group information G1 contained in the message for this purpose. The received message is passed on in the form of messages m(T12, ST) to the subscriber connections T11 and T21, on the basis of the group information G1 contained in the received message. In a corresponding manner, in the event of a state change of the subscriber connection T32, a message m(G2, N1, ST) is sent to the control unit SE1, from where it is passed on to the subscriber connections T21 and T31.

The messages relating to state changes are preferably transmitted via signaling channels to respective partner communications systems in a communications network. As already mentioned, additional information which is contained in the message relating to a state change is stored in a memory which is associated with a subscriber connection to which the state change is to be signaled. The respective state information is preferably signaled visually on a subscriber connection direct call key of a subscriber terminal TE which is associated with the respective subscriber connection. Visual signaling can be produced, for example, by light-emitting diodes flashing at different frequencies or by different color displays.

Although the present invention has been described with reference to specific embodiments, those of skill in the art will recognize that changes may be made thereto without departing from the spirit and scope of the invention as set forth in the hereafter appended claims.

We claim as our invention:

1. A method for state signaling for a subscriber connection in a communications network having at least first and second communications systems, the method comprising the steps of:
allocating at least one first subscriber connection to a first communications system;
allocating at least one second subscriber connection to a second communications system;
storing a cross-reference in at least one first memory associated with the at least one first subscriber connection;
allocating group information to the at least one first subscriber connection;
storing the group information, for message compression, in a second memory associated with at least one second subscriber connection;
sending, upon a state change of the at least one second subscriber connection, a message relating to the state change with the group information to the first communications system; and
transmitting the message relating to the state change to the at least one subscriber connection.

2. A method for state signaling for a subscriber connection in a communications network having at least first and second communications systems as claimed in claim 1, wherein, if the at least one first subscriber connection and the at least one second subscriber connection are allocated to the same communications system, a reference back to the at least one first subscriber connection is stored in the second memory and, upon the state change of the at least one second subscriber connection, the message relating to the state change is sent to the at least one first subscriber connection.

3. A method for state signaling for a subscriber connection in a communications network having at least first and second communications systems as claimed in claim 1, wherein the group information indicates the allocation of the at least one first subscriber connection to the first communications system.

4. A method for state signaling for a subscriber connection in a communications network having at least first and second communications systems as claimed in claim 1, wherein the group information contains an additional cross-reference to an identification tag, which is unique within the communications network, for the first communications system, to which the at least one first subscriber connection is allocated.

5. A method for state signaling for a subscriber connection in a communications network having at least first and second communications systems as claimed in claim 1, wherein the at least one first subscriber connection to which the group information is allocated is a member of a network-wide call transfer group.

6. A method for state signaling for a subscriber connection in a communications network having at least first and second communications systems as claimed in claim 1, wherein, for state signaling between communications systems, sum messages about state changes are sent to the respective communication systems.

7. A method for state signaling for a subscriber connection in a communications network having at least first and second communications systems as claimed in claim 1, wherein the message relating to the state change is transmitted via a signaling channel to the respective communications system.

8. A method for state signaling for a subscriber connection in a communications network having at least first and second communications systems as claimed in claim 1, wherein state information relating to the at least one second subscriber connection and corresponding to contents of the at least one first memory and in which the cross-reference to the at least one second subscriber connection is stored, is signaled at a subscriber connection direct call key on a terminal connected to the at least one first subscriber connection.
